(19) United States
(12) Patent Application Publication
(10) Pub. No.: US 2012/0318532 A1
(43) Pub. Date: Dec. 20, 2012

(54) Temperature Resistant Downhole Elastomeric Device

(75) Inventors: Nitin Y. Vaidya, Missouri City, TX (US); Iain Cooper, Sugar Land, TX (US); Kuo-Chiang Chen, Sugar Land, TX (US)

(73) Assignee: SCHLUMBERGER TECHNOLOGY CORPORATION, SUGAR LAND, TX (US)

(21) Appl. No.: 13/161,597

(22) Filed: Jun. 16, 2011

(51) Int. Cl. E21B 33/12; F04B 35/04; F01C 1/10; B32B 5/02

(52) U.S. Cl. 166/387; 166/179; 277/336; 442/59; 417/410.1; 418/48; 977/773

(57) ABSTRACT

An elastomeric-based device configured for use in high temperature downhole environments exceeding about 400° F. The device includes a carbon nanotube mesh configured to dissipate heat relative elastomeric portions thereof so as to provide temperature resistance. Thus, a majority of modulus strength of the elastomeric portions may be maintained along with device functionality even upon exposure to such temperatures. Further, the mesh may also be configured to mimic the modulus character of elastomeric portions to allow a cohesive compliance to the device as a whole. Thus, isolation packers and other expansive downhole devices may particularly benefit from such combined material configurations as detailed herein.

### FIELD

Embodiments described relate to elastomeric seals and devices configured for use in downhole environments. In particular, embodiments focus on elastomeric devices employed in high temperature, harsh environments for extended periods of time. Such devices may include packers for providing fluid isolation as well as other types of seals for protection of a variety of downhole equipment.

### BACKGROUND

Exploring, drilling and completing hydrocarbon and other wells are generally complicated, time consuming, and ultimately very expensive endeavors. As a result, over the years, a significant amount of added emphasis has been placed on well monitoring and maintenance. Once more, perhaps even more emphasis has been directed at initial well architecture and design. All in all, careful attention to design, monitoring and maintenance may help maximize production and extend well life. Thus, a substantial return on the investment in the completed well may be better ensured.

In the case of well monitoring and logging, mostly minimally-invasive applications may be utilized which provide temperature, pressure and other production related information. By contrast, well design, completion and subsequent maintenance, may involve a host of more direct interventional applications. For example, perforations may be induced in the wall of the well, debris or tools and equipment removed, etc. In some cases, the well may even be designed or modified such that entire downhole regions are isolated or closed off from production. Such is often the case where an otherwise productive well region is prone to produce water or other undesirable fluid that tends to hamper hydrocarbon recovery.

Regardless of the particular purpose, closing off well regions as noted above is generally achieved by way of setting one or more types of packers. Such packers may be set at downhole locations and serve to seal off certain downhole regions from other productive regions. Delivering, deploying and setting packers for isolation may be achieved by way of coiled tubing, or other conventional line delivery application. The application may be directed from the oilfield surface and involve a significant amount of manpower and equipment. Indeed, the application may be fairly sophisticated, given the amount of precision involved in packer positioning and setting. Thus, from a time and cost standpoint, utilization of a packer capable of remaining effective and withstanding rigors of the downhole environment may be quite significant. Indeed, setting aside the potential catastrophic effects of packer failure, even where mere packer replacement is available, several hundred thousand dollars worth of lost time and production may be incurred.

In order to avoid the significant costs associated with packer replacement, particular focus may be drawn to the utilization of packers constructed of materials which operate well over the long term in the downhole environment. For example, in many cases metallic seals are utilized where downhole conditions present particularly high temperatures, say in excess of 400° F. or so. While somewhat less compliant than a more conventional elastomeric seal, metal-based mechanical packers, for example, may function quite well in providing and maintaining downhole isolation even in the presence of such high temperatures. This is especially the case where a corresponding well casing defines the well wall in a sufficiently smooth and uniform manner. That is, with such a casing available, an effective sealing interface between the packer and corresponding casing is provided.

Unfortunately, a metal-based seal or packer as described above is notably lacking in the compliance and viscoelastic properties that are found in more conventional nonmetallic seals of plastics and elastomers. As a result, where a perfectly smooth and uniform casing is unavailable, the metal-based seal may fail to provide adequate isolation. Once more, metal-based seals remain subject to deterioration in the face of harsh well conditions apart from high temperatures, such as exposure to sulfuric acid, carbon dioxide and other harsh downhole chemicals.

In light of the drawbacks to metal-based seals and packers, elastomeric-based devices are more commonly used to provide downhole isolation even in the case of high temperature wells. Thus, material compliance in forming a seal is more assured. Unfortunately, as alluded to above, exposure of such materials to high temperatures can lead to failure in relatively short order. More specifically, upon exposure to temperatures in excess of about 450° F., even for less than a couple of hours, a 90% modulus loss is to be expected for a conventional elasomeric-based seal material. This translates into a seal-ability of well under 1,000 PSI, far below what would be considered effective isolation for most downhole circumstances.

A downhole packer configured for use in high temperature environments is generally equipped with additional supportive features to help compensate for the likely material failure of the seal as noted above. For example, durable metal-based anti-extrusion or backup rings are generally disposed adjacent the seal material. Thus, as the seal material is compressibly expanded against a well wall for isolation, it is also supportively retained and held together from both above and below. Indeed, further structural retaining guidance may also be provided in the form of curved fold back shoes disposed between each backup ring and the seal. In this manner, even an elastomeric seal that loses the majority of its modulus may be effectively held together for a period.

Unfortunately, structurally holding the seal material together in the face of deteriorating modulus will not always be enough to fully maintain seal-ability of the packer. Rather, depending on the surrounding pressure, the structural failure of the elastomeric material in terms of its deteriorating modulus may eventually lead to packer failure. Thus, isolation at the downhole location is lost, irrespective of the presence of other structurally supportive retaining features adjacent the elastomer. As a result, in the face of high temperature environments, operators are left with the decision between employing metallic seals which may fail to sealingly interface the well and elastomeric ones that may fail over the long term.

### SUMMARY

An elastomeric-based downhole device is provided. The device includes a transversing carbon nanotube mesh of intermittent physical interconnections along with an elastomeric material incorporated therewith. With the combination of the mesh and elastomeric material, the device is configured to retain a majority of its modulus of strength even upon exposure to downhole temperatures exceeding 400° F.

### BRIEF DESCRIPTION OF THE DRAWINGS

FIG. 1 is a side view of an embodiment of a temperature resistant elastomeric-based downhole packer for providing fluid isolation in a well.

FIG. 2A is an enlarged view of interfacing elastomeric-based and carbon-nanotube based portions of the packer of FIG. 1 taken from 2-2 thereof.

FIG. 2B is an enlarged view of an alternate embodiment of the interfacing portions of FIG. 2A taken from 2-2 of FIG. 1.

FIG. 3 is an overview of an oilfield accommodating a well for deployment of the packer of FIG. 1 therein.

FIG. 4 is an enlarged view of the packer of FIG. 1 sealingly deployed in the well at the oilfield of FIG. 3 for fluid isolation thereat.

FIG. 5 is a chart comparing elastomeric and carbon nanotube material behaviors in terms of strength and modulus over a wide range of temperatures.

FIG. 6 is a flow-chart summarizing an embodiment of employing a temperature resistant downhole device in a well for isolation.

### DETAILED DESCRIPTION

Embodiments herein are described with reference to certain types of downhole elastomeric-based devices. For example, embodiments detailed herein tend to focus on elastomeric-based packers for downhole isolation applications. However, a variety of alternative applications may employ embodiments of elastomeric-based tools and techniques as detailed herein. Such devices may include downhole joints, shock absorbers and protective layering/housings for cables, pumps, motors and other tools. Regardless, embodiments detailed herein include elastomeric-based features that are coupled with carbon nanotube material for resistance to high temperature downhole environments.

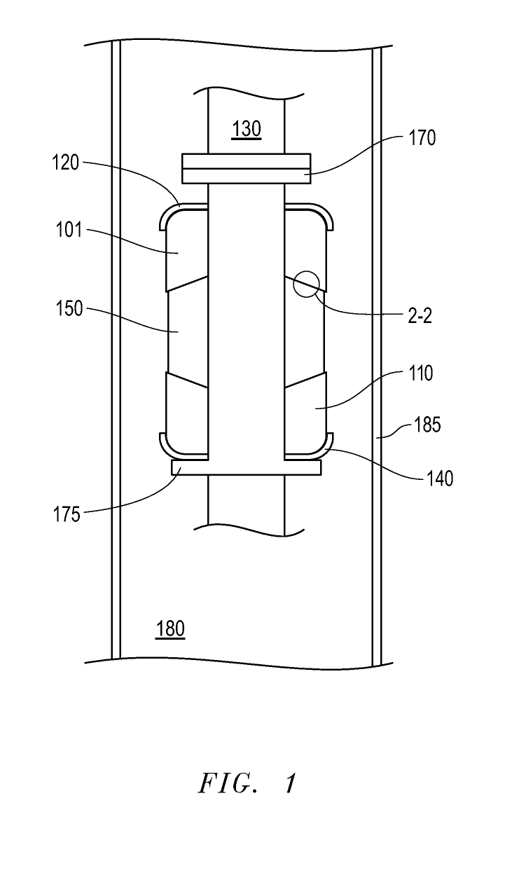

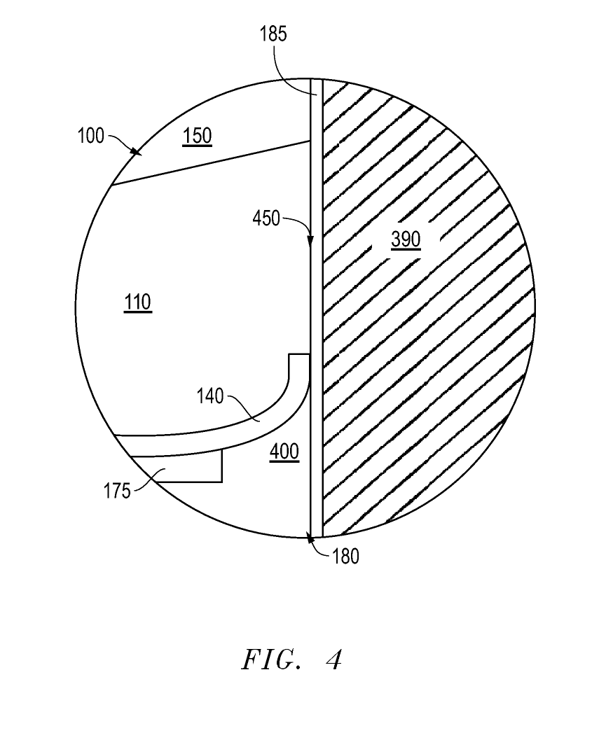

Referring now to FIG. 1, a side view of an embodiment of a temperature resistant elastomeric-based downhole packer 100 is shown. The packer 100 is configured for providing fluid isolation at a downhole location in a depicted well 180. More specifically, the packer 100 is equipped with an elastomeric-based portion 150 for compressible engagement with a casing 185 defining the well 180 so as to isolate a downhole region 400 of the well 180 from other portions thereof (see FIG. 4).

In the embodiment shown, the packer 100 includes the noted elastomeric-based portion 150 disposed between upper 101 and lower 110 carbon nanotube portions. The nanotube portions 101, 110 may be configured to serve as conventional anti-extrusion devices relative the adjacent elastomeric-based portion 150. More importantly however, these portions 101, 110 may also serve to substantially dissipate heat of the well environment in a manner that extends and/or preserves the structural life of the elastomeric-based portion 150. For example, left unaided, a conventional packer elastomer such as tetrafluoroethylene propylene (FEPM) or perfluoroelastomer (FFKM) would largely liquefy in a high temperature well environment. More specifically, as detailed further below, in an embodiment where the well 180 exceeds 400° F. to 450° F., a 90% loss of modulus or strength would be expected for such materials. However, as also described further below, the presence of heat dissipating nanotube portions 101, 110 may be utilized to maintain the functionality of the elastomeric-based portion 150 disposed therebetween even at temperatures well above 400° F.

The nanotube portions 101, 110 of FIG. 1 are of a mesh that mimics the modulus of the adjacent elastomeric-based portion 150. So, for example, in a conventional packer deployment, tubing structure 130 may be employed in a plunger-like manner drawing upper 170 and lower 175 retention rings closer to one another. In this manner, the similarly compliant elastomeric 150 and nanotube 101, 110 portions, may be forced in a radially outward manner until sealing engagement with the casing 185 is achieved by the elastomeric-based portion 150.

Continuing with reference to FIG. 1, the nanotube portions 101, 110 do not serve to directly create sealing engagement with the casing 185. However, their compliant nature, akin to the elastomeric-based portion 150, serves to displace and radially expand the fold back shoes 120, 140 into a structural setting engagement with the casing 185. That is, just as in the case of a more conventional packer, the temperature resistant packer 100 is outfitted with structural supports such as the above noted rings 170, 175 and fold back shoes 120, 140 to help retain and hold together portions of the deploying packer 100. In fact, in one embodiment, the rings 170, 175 are also constructed of nanotube material to further aid in heat dissipation and temperature resistance of the packer 100.

Unlike an elastomeric material, the carbon nanotube portions 101, 110 may be of greater structural soundness for displacing and expanding the shoes 120, 140. Thus, the likelihood of deployment damage to the nanotube portions 101, 110 upon compressive action against, generally non-uniform metal-based shoes 120, 140, is minimized. So, in addition to the primary advantage of providing temperature resistance to the packer 100, the nanotube portions 101, 110 may play a significant role in maintaining the physical retention of the packer 100 in the face of significant pressure exerted thereon.

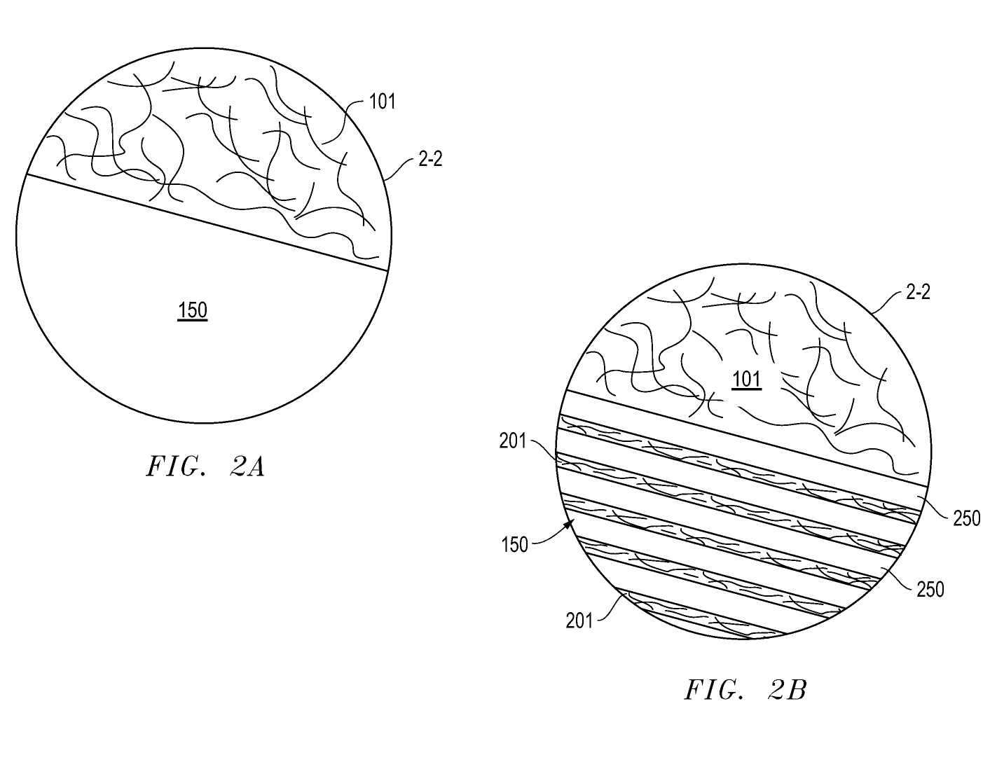

Referring now to FIGS. 2A and 2B, enlarged views taken from 2-2 of FIG. 1 are shown. In these depictions, alternate embodiments of interfaces between the elastomeric-based portion 150 and one of the nanotube portions 101 are depicted. More specifically, FIG. 2A reveals the nanotube portion 101 adjacent an elastomeric-based portion 150 of unitary construction whereas FIG. 2B reveals an embodiment of the elastomeric-based portion 150 that is of alternating nanotube 201 and elastomer 250 layers.

With particular reference to FIG. 2A, the elastomeric-based portion 150 is represented as a smooth elastomer-based material which may be FEPM, FEKM or a host of suitably compliant elastomers or combinations thereof. Further, the elastomers selected may be somewhat temperature resistant, for example, to 200° F., irrespective of adjacent heat dissipating nanotube portions (e.g. 101). By contrast, the adjacent nanotube portion 101 is represented as a wire mesh, similar in appearance to steel wool. Thus, as alluded to above and with added reference to FIG. 1, this portion 101 is not configured to aid the packer 100 in forming a sealing engagement with the casing 185. Nevertheless, the modulus of the nanotube portion 101 is tailored to mimic that of the elastomeric-based portion 150 to allow the packer 100 to behave in a uniformly compliant nature in interfacing the casing 185.

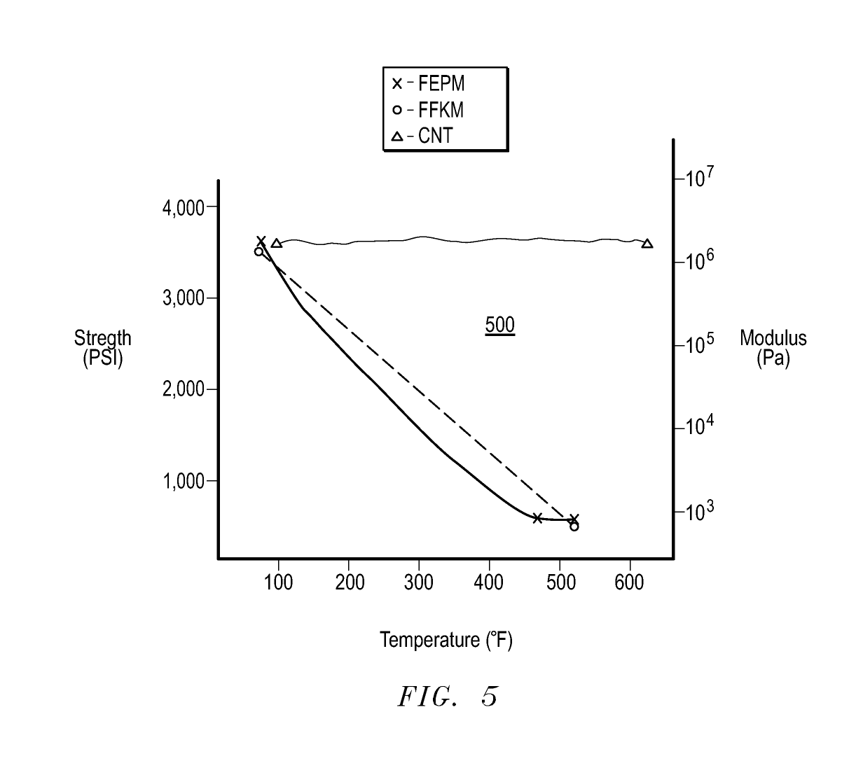

More notable than providing durable retentive support and mimicking the modulus of the elastomeric-based portion 150, the nanotube portion 101 is configured to provide substantial temperature resistance to the packer 100. More specifically, the nanotube portion 101 may itself display temperature invariance in terms of change in modulus even at temperatures exceeding 625° F. This is illustrated further with reference to the chart of FIG. 5 as detailed below. Further, in order to attain such temperature resistant characteristics, the nanotube portion 101 may be made up of long transversing carbon nanotubes with a high density of intermittent physical interconnections. Such material makeup and characteristics are detailed in Carbon Nanotubes with Temperature-Invariant Viscoelasticity from −196 to 1000° C., M. Xu et al., Science Magazine, vol. 330, 1364 (2010), incorporated herein by reference in its entirety.

Nanotube-based materials as described in the M. Xu reference may mimic the compliant nature of a variety of elastomers as alluded to above. However, unlike conventional elastomers, such nanotube-based materials may undergo no significant modulus change when exposed to temperatures well in excess of 625° F. Thus, the nanotube portion 101 may be incorporated into a packer 100 adjacent an elastomeric-based portion 150 as depicted in FIG. 1. As a result, the inherent heat dissipating nature of the mesh nanotube portion 101 may serve to substantially prevent extrusion or liquification of the elastomeric-based portion 150 upon exposure to high temperatures, even those ranging between about 425° F. and 625° F. or so.

Continuing with reference to FIG. 2A, the nanotube portion 101 may be manufactured and processed according to conventional techniques as detailed in the M. Xu reference. For example, reactive ion etching of a catalyst film may be utilized followed by water assisted chemical vapor deposition (CVD). Increase in solids density as noted above may then be achieved by way of conventional compression.

With specific reference to FIG. 2B, an alternate embodiment of the interfacing of the portions 101, 150 are shown, again taken from 2-2 of FIG. 1. Notably, in this embodiment, the elastomeric-based portion 150 is not of a smooth unitary elastomer variety as in FIG. 2A. Rather, this portion 150 is constructed of a host of alternating nanotube 201 and elastomer 250 layers. In such an embodiment, the elastomeric-based portions 150 is traversed by a multitude of heat dissipating elements (the nanotube layers 201). That is, in this embodiment heat dissipation for the benefit of the elastomeric-based portion 150 is not limited solely to reliance on the adjacent nanotube portion 101. Rather, heat dissipation, and indeed heat tolerance of the entire packer 100, is enhanced by the distribution of heat dissipating nanotube layers 201 throughout the body of the elastomeric-based portion 150 (see FIG. 1).

Even though the nanotube layers 201 lack sealing capacity, the presence of alternating elastomer layers 250 ensure that the elastomeric-based portion 150 may provide adequate seal capacity to the packer 100 of FIG. 1. Similarly, with the nanotube layers 201 tailored to mimic the compliant nature of the elastomer layers 250, no significant sacrifice to mechanical functionality of the packer 100 is experienced in terms of deployment and engagement with the casing 185. Thus, an overall heat tolerance of the elastomeric-based portion 150 may be effectively and reliably driven up to well over 425° F. without any reasonable concern over packer functionality.

In yet another embodiment, the elastomeric-based portion 150 may actually be made up of a mesh nanotube substructure having conventional polymer extruded or infused thereinto. That is, as opposed to alternating layers of nanotube 201 and elastomer 250, these materials may be more uniformly incorporated with one another. While such an embodiment may provide a lesser degree of heat dissipation due to potential disruption of cross-linking in the nanotube substructure, there may be circumstances where physical uniformity of the elastomeric-based portion 150 is of greater import.

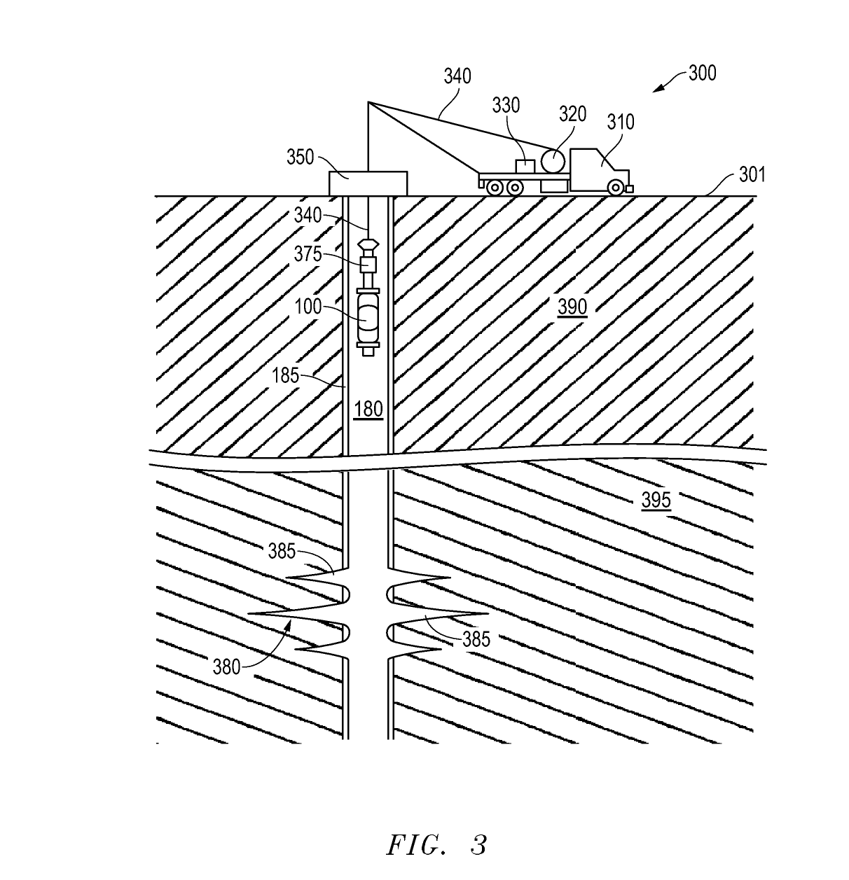

Referring now to FIG. 3, an overview of an oilfield 301 is shown which accommodates the well 180 of FIG. 1 for deployment of the packer 100 therein. As shown, the well 180 is defined by the noted casing 185 and traverses various formation layers 390, 395. Indeed, one such layer 395 may include a production region 380 with perforations 385 from which production fluid may be drawn into the main bore of the well 180. At some point, however, an operator decision may be made to seal off the production region, for example, due to the emergence of water, the need for temporary intervention thereabove, or any number of other reasons. Thus, the packer 100 may be deployed into the well 180.

In the embodiment of FIG. 3, surface equipment 300 for delivery and deployment of the packer 100 is provided. Namely, a mobile wireline truck 310 with drum 320 is positioned at the oilfield 301 for deployment of a wireline cable 340. The wireline 340 may traverse a well head 350 at the top of the well 180 so as to deliver the packer 100 therein. In the embodiment shown, a deployment mechanism 375 such as a hydrostatic set module accompanies the packer 100 for actuating sealable deployment thereof once the packer 100 is positioned at a target location in the well 180. However, a variety of different types of deployment mechanisms may be utilized.

The mobile wireline truck 320 is also outfitted with a control unit 330 for directing delivery and deployment of the packer 100 as shown. For example, the unit 330 may be utilized to direct the depth of the packer 100, the triggering of its sealing deployment, or to monitor conditions in the well 180, such as temperature. Regardless, as detailed above and further below, even very high temperatures are unlikely to have any significant impact on the sealing functionality of the temperature resistant packer 100 that is provided.

Referring now to FIG. 4, with added reference to FIG. 3, an enlarged view of the packer 100 of FIG. 1 is now shown sealingly deployed in the well 180 at the oilfield 301. In the fully deployed state, the fluid isolation provided by the packer 100 is readily apparent. Namely, a downhole portion 400 of the well 180 is cut off from fluid communication with the surface of the oilfield 301. Thus, fluid from the production region 380 is prevented from moving uphole beyond the location of the packer 100, for example, where such fluid includes water or other undesired contaminant as noted above.

In the process of fully deploying the packer 100 as depicted in FIG. 4, a fold back shoe 140 is shown interfacing the casing 185. As noted above, the shoe 140 is of a solid, generally metal-based construction. While supportive of the underlying packer structure, the shoe 140 is not particularly compliant in nature. Nevertheless, as also indicated above, the nanotube structure that makes up the portion 110 of the packer 100 interfacing the shoe 140 is both compliant and of an enhanced structural soundness. Thus, it is well suited for interfacing compliance about the comparatively non-uniform shoe 140. Ultimately this translates into a reliably snug fit at the interface 450 of the packer 100 and the casing 185 which defines the well 180. As such, the sealing engagement provided by the elastomeric-based portion 150 is not only made more temperature resistant as described above, but also structurally enhanced.

Referring now to FIG. 5, with the compliant nature of different material types in mind, a chart is shown comparing different elastomeric and carbon nanotube material behaviors. The comparisons are shown in terms of stress and strain curves of strength and modulus over a wide range of temperatures. Further, the materials compared include conventional elastomeric packer materials such as FEPM (x) and FFKM (o) as referenced above. Additionally, carbon nanotube material (CNT (Δ)), such as the long transversing variety described above, is also depicted.

Viewed individually, the elastomeric materials (x, o) are shown of a given sealing strength at relatively low temperature (e.g. well above 3,000 PSI). However, as temperatures are increased, such materials readily break down and, in terms of effective downhole sealing, are rendered largely ineffective (e.g. unable to hold a 1,000 PSI seal). This comports with conventional downhole seal material described above, unable to function as intended when exposed to high temperature downhole environments.

By contrast to conventional elastomers (x, o), the CNT material (Δ) is of a modulus that mimics viscoelasticity of the elastomers (x, o), but is largely unaffected by temperatures over the depicted range of 100° F.-600° F. or so. This bodes well for the use of such materials even in the face of more extreme downhole temperatures. However, given that such mesh material is not configured to hold a seal, it's modulus over the indicated temperature range is depicted in terms of resistance to compression (pascals (Pa)). Modulus measurements aside, this also means that in order to form an effective seal, the CNT material (Δ) may be combined with elastomers such as FEPM (x) or FFKM (o).

With added reference to FIG. 1, combining the CNT material (Δ) with a more conventional elastomer material (x, o), may be done in order to form a packer 100 as described above. The resulting overall packer structure would thus display a temperature resistance of somewhere between that of the elastomer (x, o) and that of the CNT (Δ) employed (e.g. at area 500 in the chart of FIG. 5). The particular degree to which temperature resistance of the packer 100 is enhanced, approaching the level of the CNT (Δ) may be determined by a host of factors. For example, the amount of CNT material (Δ) utilized (e.g. at portions 101, 110), the particular type of layering employed (e.g. for the embodiment of FIG. 2B), and other factors may contribute to the amount of heat dissipation actually exhibited by the CNT material (Δ). Regardless, the degree of enhancement may be determined as a matter of design choice, depending on considerations such as the overall properties sought for the packer 100 balanced against likely downhole temperatures to be encountered.

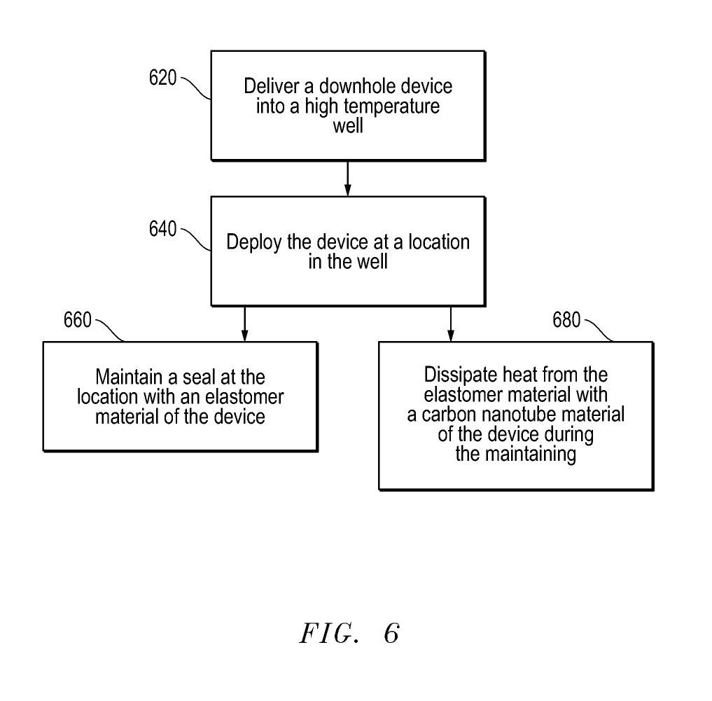

Referring now to FIG. 6, a flow-chart is shown summarizing an embodiment of employing a temperature resistant downhole device in a high temperature well. Namely, the device may be delivered as indicated at 620 and deployed as indicated at 640. With reference to the embodiments detailed above, a packer may accordingly be delivered and deployed, although other types of devices utilizing temperature resistance as detailed herein may also be similarly delivered and deployed.

Once in position, an elastomer of the deployed device may be utilized to form a seal at the downhole location as indicated at 660. Further, as indicated at 680, dissipation of heat from the elastomer may be achieved through use of a carbon nanotube material of the device. As described above, these nanotube portions may be discrete sections of a packer. Additionally, nanotube material may be incorporated into a fold back shoe, supplemental antiextrusion rings and elsewhere throughout the packer.

Further, devices other than packers may take advantage of the unique nanotube-elastomer combinations detailed herein. For example, cables, housings for electrical submersible pumps, progressive cavity pumps or potheads may utilize such sealing and heat dissipating material combinations. Such material choices may also be incorporated into downhole bending subs, tubular joints and main bodies, shock absorbers, and mud motor components such as sealing surfaces between stators and rotors.

Embodiments described hereinabove provide material combinations for devices that allow for enhanced downhole temperature resistance. More specifically, enhanced sealing under higher temperatures is provided by reduction in modulus deterioration that is often experienced in the face of such high temperatures. Thus, packers and other seal-reliant devices may display extended downhole life in such environments.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Furthermore, the foregoing description should not be read as pertaining only to the precise structures described and shown in the accompanying drawings, but rather should be read as consistent with and as support for the following claims, which are to have their fullest and fairest scope.

We claim:

1. A downhole elastomeric-based device comprising:
a transversing carbon nanotube mesh portion of intermittent physical interconnections; and
an elastomeric material portion incorporated with said mesh portion, the device to retain a majority of modulus strength upon exposure to downhole temperatures exceeding about 400° F.

2. The device of claim 1 wherein said elastomeric material portion is of unitary elastomeric construction disposed adjacent said mesh portion.

3. The device of claim 1 wherein said elastomeric material portion is of alternating layers of elastomeric material and carbon nanotube mesh.

4. The device of claim 1 wherein said elastomeric material portion is disposed through said mesh portion.

5. The device of claim 1 configured as one of a packer, a joint, tubing, a bending sub, a shock absorber, a cable, a pump housing component, and a mud motor component.

6. The device of claim 5 wherein the pump housing component is a component of a progressive cavity pump, an electrical submersible pump and a pothead.

7. The device of claim 5 wherein the mud motor component is a sealing surface for disposal between a stator and a rotor.

8. An elastomeric-based material configured to retain a majority of modulus strength upon exposure to downhole environments exceeding about 400° F., the material incorporated with a transversing carbon nanotube mesh of intermittent physical interconnections.

9. The material of claim 8 being structurally resistant to temperatures in excess of 200° F. in absence of the mesh.

10. The material of claim 9 selected from a group consisting of tetrafluoroethylene propylene and perfluoroelastomer.

11. The material of claim 8 wherein the mesh is configured to display a modulus of greater than about 10⁶ Pa.

12. The material of claim 8 wherein the mesh is configured to display a modulus mimicking that of said material.

13. The material of claim 8 wherein the mesh is configured to display substantial invariance in modulus upon exposure to temperatures of up to about 625° F.

14. A temperature resistant packer for use in a high temperature well, the packer comprising:
a transversing carbon nanotube mesh portion of intermittent physical interconnections; and
an elastomeric material portion disposed adjacent said mesh portion to retain a majority of modulus strength upon exposure to temperatures in excess of about 400° F.

15. The packer of claim 14 wherein said mesh portion is a first mesh portion positioned adjacent an uphole end of said elastomeric material portion, the packer further comprising a second transversing carbon nanotube mesh portion of intermittent physical interconnections positioned adjacent a downhole end of said elastomeric material portion.

16. The packer of claim 14 wherein said elastomeric material portion is of alternating layers of elastomeric material and carbon nanotube mesh.

17. The packer of claim 14 further comprising a fold back shoe to interface said mesh portion for radial expansion upon deployment of the packer at a location in the well.

18. The packer of claim 15 further comprising a retention ring disposed adjacent said fold back shoe to provide structural support for the deployment, at least one of said ring and said shoe comprised of a transversing carbon nanotube mesh of intermittent physical interconnections.

19. A method of employing a downhole elastomeric-based device in a high temperature well, the method comprising:
deploying the device at a location within the well;
maintaining a seal at the location with an elastomer material of the device; and
dissipating heat from the elastomer material with a transversing carbon nanotube mesh of intermittent physical interconnections during said maintaining.

20. The method of claim 19 wherein the device is a packer, said maintaining comprising providing fluid isolation at the location via the seal.
